(19) United States
(12) Patent Application Publication
(10) Pub. No.: US 2017/0365168 A1
(43) Pub. Date: Dec. 21, 2017

(54) RECORDING MEDIUM, TRIGGER CONDITION DETERMINING METHOD, AND TRIGGER CONDITION DETERMINING APPARATUS

(71) Applicant: FUJITSU LIMITED, Kawasaki-shi (JP)

(72) Inventors: Kiyohide OMIYA, Kawasaki (JP); Takashi SHIMADA, Shinagawa (JP); Kosei TAKANO, Fujimino (JP)

(73) Assignee: FUJITSU LIMITED, Kawasaki-shi (JP)

(21) Appl. No.: 15/691,018

(22) Filed: Aug. 30, 2017

Related U.S. Application Data
(63) Continuation of application No. PCT/JP2016/054294, filed on Feb. 15, 2016.

(30) Foreign Application Priority Data
Mar. 12, 2015 (JP) 2015-049102

(51) Int. Cl. G08G 1/09; G08G 1/16

(52) U.S. Cl. CPC G08G 1/093; G08G 1/164; G08G 1/166

(57) ABSTRACT

A non-transitory, computer-readable recording medium stores therein a trigger condition determining program that causes a computer to execute a process including distributing and allocating to plural vehicle groups, a pattern candidate when plural pattern candidates of a trigger condition for control in a vehicle corresponding to driving operation is present, the pattern candidate being each pattern candidate of the plural pattern candidates; evaluating the trigger condition corresponding to the allocated pattern candidate, based on a change in travel information before and after an application of the trigger condition corresponding to the allocated pattern candidate; and setting among plural trigger conditions, a trigger condition having a relatively high evaluation or satisfying a predetermined standard to be a trigger condition that is to be applied in a service provided to the plural vehicle groups.

### CROSS REFERENCE TO RELATED APPLICATIONS

This application is a continuation application of International Application PCT/JP2016/054294, filed on Feb. 15, 2016, which claims priority from a Japanese Patent Application No. 2015-049102 filed on Mar. 12, 2015, the contents of which are incorporated herein by reference.

### FIELD

The embodiments discussed herein relate to a recording medium, a trigger condition determining method, and a trigger condition determining apparatus.

### BACKGROUND

Conventionally, there is a system that collects travel information of a vehicle such as the position, speed, acceleration, driving operation, etc. of the vehicle. Further, there is a technique of performing control in a vehicle to prevent an occurrence of a traffic accident, based on collected travel information of the vehicle. For example, notification is given in the vehicle as control in the vehicle.

As a prior art, for example, an outcome measuring system automatically acquires for each measure, cost and outcomes for measures related to website operation whereby an outcome obtained by implementing a certain measure and the required cost are calculated. Further, for example, when a user is performing an action according to an action plan and despite awareness, an expected effect is not obtained, a more effective action plan having a same attribute as before a change is selected and provided to the user. For example, refer to Japanese Laid-Open Patent Publication Nos. 2013-73615 and 2012-128798.

### SUMMARY

According to an aspect of an embodiment, a non-transitory, computer-readable recording medium stores therein a trigger condition determining program that causes a computer to execute a process including distributing and allocating to plural vehicle groups, a pattern candidate when plural pattern candidates of a trigger condition for control in a vehicle corresponding to driving operation is present, the pattern candidate being each pattern candidate of the plural pattern candidates; evaluating the trigger condition corresponding to the allocated pattern candidate, based on a change in travel information before and after an application of the trigger condition corresponding to the allocated pattern candidate; and setting among plural trigger conditions, a trigger condition having a relatively high evaluation or satisfying a predetermined standard to be a trigger condition that is to be applied in a service provided to the plural vehicle groups.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of an example of a trigger condition determining method according to an embodiment;

FIG. 2 is a diagram depicting an example of an operation support system 200 according to the embodiment;

FIG. 3 is a block diagram of one example of hardware of a determining apparatus 100;

FIG. 4 is a diagram depicting an example of the contents of a travel information table 400;

FIG. 5 is a diagram depicting an example of the contents of a location information table 500;

FIG. 6 is a diagram depicting an example of the contents of a detection condition master 600;

FIG. 7 is a diagram depicting an example of the contents of an extraction condition master 700;

FIG. 8 is a diagram depicting an example of the contents of a pattern master 800;

FIG. 9 is a diagram depicting an example of the contents of a results information table 900;

FIG. 10 is a block diagram of an example of hardware of an onboard vehicular apparatus N;

FIG. 11 is a block diagram of an example of functional configuration of the determining apparatus 100;

FIG. 12 is a diagram depicting an example of allocation of pattern candidates of a trigger condition;

FIG. 13 is a diagram depicting a flow of trigger condition determination;

FIG. 14 is a diagram depicting an example of trigger condition replacement;

FIG. 15 is a diagram depicting an example of an output screen;

FIG. 16 is a flowchart depicting an example of a procedure of a replacement process; and

FIG. 17 is a flowchart depicting an example of a procedure of an exclusion process.

### DESCRIPTION OF THE INVENTION

Embodiments of a trigger condition determining program, a trigger condition determining method, and a trigger condition determining apparatus of the present invention are described in detail with reference to the accompanying drawings.

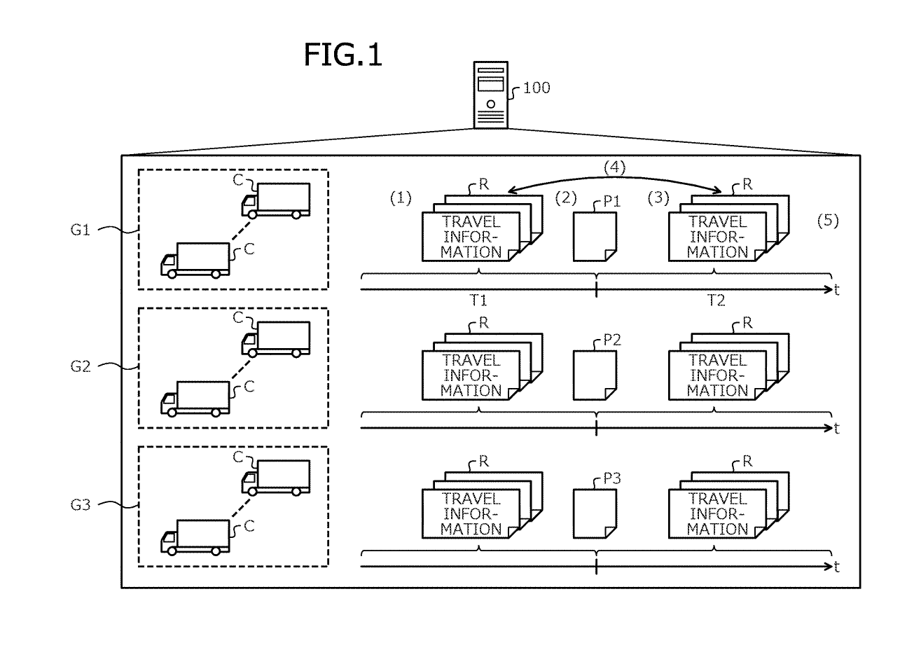

FIG. 1 is a diagram of an example of the trigger condition determining method according to an embodiment. In FIG. 1, a trigger condition determining apparatus 100 is a computer configured to, for example, reduce the burden on a passenger of a vehicle C or avoid congestion, prevent an occurrence of a traffic accident by determining conditions for performing control in the vehicle according to the driving operation of the vehicle C. The vehicle C is, for example, an automobile, a motorcycle, a bicycle, or the like. In the description hereinafter, the trigger condition determining apparatus 100 may be indicated as simply “determining apparatus 100”. Further, a condition for performing control in the vehicle C according to the driving operation of the vehicle C may be indicated as a “trigger condition”.

Here, it is conceivable that a computing apparatus equipped on the vehicle C performs control in the vehicle C when a trigger condition based on a sudden braking count of another vehicle C is satisfied whereby an occurrence of a traffic accident involving the vehicle may be prevented. For example, the computing apparatus may use, as trigger condition, an instance in which the vehicle C enters a place where the number of times another vehicle C braked suddenly when passing through in the past is equal to or greater than a threshold and when the trigger condition is satisfied, may perform control in the vehicle C. In this case, the computing apparatus, for example, as control in the vehicle C, gives notification in the vehicle C that the vehicle C is passing through a dangerous zone cautioning a passenger of the vehicle C whereby an occurrence of a traffic accident involving the vehicle C may be prevented.

However, it is difficult for a manager of the computing apparatus to judge what type of trigger condition configured in the computing apparatus will suppress an occurrence of a traffic accident. For example, it is difficult for the manager of the computing apparatus to judge whether using, as a trigger condition, an instance of the vehicle C entering a place where the number of times another vehicle C braked suddenly when passing through in the past is equal to or greater than a threshold can suppress the occurrence of a traffic accident involving the vehicle C. Therefore, even when the vehicle C has entered a place where giving notification in the vehicle C is desirable to prevent the occurrence of a traffic accident involving the vehicle C, the notification in the vehicle C may not be given and the occurrence of a traffic accident involving the vehicle C may not be prevented.

Further, when the vehicle C has entered a place other than a place where giving notification in the vehicle C is desirable, notification in the vehicle C may be given whereby a large number of notifications may be given in the vehicle C. As a result, whenever notification is given, a passenger of the vehicle C may have difficulty knowing whether caution against a traffic accident should be exercised. Further, as a result of a large number of notifications being given in the vehicle C, a passenger of the vehicle C may become accustomed to the notifications in the vehicle C and disregard the notifications in the vehicle C whereby an occurrence of a traffic accident involving the vehicle C may not be prevented. Further, as a result of a large number of notifications being given in the vehicle C, a passenger of the vehicle C may perform driving operations exercising caution against a traffic accident every time a notification is given in the vehicle C whereby the physical or mental burden on a passenger of the vehicle C increases.

Further, it is conceivable that the computing apparatus equipped on the vehicle C performs control in the vehicle C when a trigger condition based on a position of another traveling vehicle C is satisfied whereby congestion may be avoided by the vehicle C. For example, the computing apparatus may use, as a trigger condition, an instance in which the vehicle C enters a congested place where a certain number or more other vehicles C are traveling and when the trigger condition is satisfied, may give notification in the vehicle C, of a route bypassing the congested place. Nonetheless, it is difficult for the manager of the computing apparatus to judge what type of trigger condition configured in the computing apparatus may efficiently avoid congestion. Therefore, even when it is desirable for the vehicle C to bypass a congested place, notification of a route bypassing the congested place may not be given whereby the time that it takes for the vehicle C to reach a destination may increase. Further, even when the vehicle C needs not bypass a congested place, notification of a bypass route may be given whereby the time that it takes for the vehicle C to reach the destination may increase. Thus, in the present embodiment, the trigger condition determining method of determining a condition enabling control in the vehicle C to be enabled is described.

In the example depicted in FIG. 1, the determining apparatus 100 is configured to collect from vehicles C included in plural vehicle groups G1 to G3, travel information R of the vehicles C. The travel information R is, for example, information including the position of the vehicles C, the speed and acceleration of the vehicles C, contents of the driving operation of the vehicles C, etc.

Further, the determining apparatus 100 stores patterns P1 to P3 as pattern candidates for a trigger condition. A pattern of a trigger condition is expressed as, for example, a combination of a condition of detecting a zone prone to sudden braking and a condition of extracting from the zone prone to sudden braking, a notification place where notification is to be given in the vehicle C.

(1) The determining apparatus 100, during a first period T1, collects the travel information R of each of the vehicles C included in the plural vehicle groups G1 to G3. The determining apparatus 100, for example, during the period T1, collects from each of the vehicles C of the plural vehicle groups G1 to G3, the travel information R including the acceleration of the vehicles C of the determining apparatus 100.

(2) The determining apparatus 100, when the first period T1 ends, applies each of the patterns P1 to P3 to each of the plural vehicle groups G1 to G3. The determining apparatus 100, for example, when each of the vehicles C included in the vehicle group G1 satisfies the pattern P1, configures the pattern P1 in the vehicles C included in the vehicle group G1 or in an onboard vehicular apparatus equipped on the vehicles C so that control is performed in the vehicles of the determining apparatus 100. As a result, the determining apparatus 100 may prevent an occurrence of a traffic accident involving the vehicles C included in the plural vehicle groups G1 to G3.

(3) The determining apparatus 100, during a second period T2 subsequent to the first period T1, collects the travel information R from each of the vehicles C that are included in the plural vehicle groups G1 to G3 and to which the patterns P1 to P3 have been applied. The determining apparatus 100, for example, during the period T2, collects from each of the vehicles C included in the plural vehicle groups G1 to G3, the travel information R including the acceleration of the vehicles C of the determining apparatus 100.

(4) The determining apparatus 100 evaluates each of the patterns P1 to P3, based on the travel information R collected at (1) and (3). The determining apparatus 100, for example, calculates the sudden braking count before and after application of each of the patterns P1 to P3, based on the acceleration of the vehicles C included in the collected travel information R. Sudden braking is, for example, a state in which the acceleration of a vehicle C in a rearward direction of the vehicle C is a threshold or greater.

The determining apparatus 100 calculates an evaluation value for each of the patterns P1 to P3 so that the evaluation value is higher for a pattern P1 to P3 for which the sudden braking count is lower to a greater extent after application of the pattern P1 to P3. The determining apparatus 100 may judge, without calculating an evaluation value, evaluation to be favorable the lower the sudden braking count is. Further, the determining apparatus 100, after application of a pattern, may calculate an evaluation value of the pattern so that the evaluation value is higher for a lower ratio of the sudden braking count to the number of vehicles traveling.

(5) The determining apparatus 100 determines a pattern having a relatively high evaluation or a pattern satisfying a predetermined standard among the patterns P1 to P3 as a pattern of a trigger condition to be applied in a service for the plural vehicle groups G1 to G3. The determining apparatus 100, for example, determines the pattern having the highest evaluation value calculated at (4) to be the pattern of the trigger condition. Further, the determining apparatus 100 may determine, as the pattern of the trigger condition, a pattern having an evaluation value calculated at (4) equal to or higher than a threshold.

As a result, the determining apparatus 100 may determine, as a pattern of a trigger condition, a pattern that may reduce the sudden braking count after application, among pattern candidates of a trigger condition. In other words, the determining apparatus 100 may determine, as a pattern of a trigger condition, a pattern that may reduce the sudden braking count and that has a high possibility of preventing an occurrence of a traffic accident. The determining apparatus 100 may apply the determined pattern of a trigger condition to each of the plural vehicle groups G1 to G3 and increase the possibility that an occurrence of a traffic accident involving the vehicles C of the plural vehicle groups G1 to G3 may be prevented. Further, the determining apparatus 100, at a place other than a place where giving notification in the vehicles C thereof is desirable to prevent an occurrence of a traffic accident involving the vehicles C thereof, may suppress giving notification in the vehicles C thereof, enabling a reduction in the burden on a passenger of the vehicles C thereof.

The determining apparatus 100 may replace among the patterns P1 to P3, a pattern having a relatively low evaluation or a pattern not satisfying a predetermined standard with a new pattern. The determining apparatus 100 may recursively perform processes identical to those at (2) to (5) with respect to the plural patterns including the replaced pattern. As a result, the determining apparatus 100 may search for a pattern having a higher possibility of preventing an occurrence of a traffic accident.

Here, although as case has been described in which the determining apparatus 100 determines, as a pattern of a trigger condition, a pattern that among pattern candidates of a trigger condition, reduces the sudden braking count to a greater extent after application than before application, configuration is not limited hereto. For example, the determining apparatus 100 may determine, as a pattern of a trigger condition, a pattern for which the sudden braking count is lowest after application, a pattern for which the sudden braking count is less than a threshold, or the like, among pattern candidates of a trigger condition.

Here, although a case has been described in which the determining apparatus 100 extracts a notification place from a zone prone to sudden braking, configuration is not limited hereto. For example, the determining apparatus 100 may extract a notification place from any of a zone prone to rapid acceleration, a zone prone to abrupt steering actions, a zone prone to hazard light use, a zone prone to speeding, and the like. Here, although a case has been described in which the determining apparatus 100 determines a trigger condition for the vehicle C, configuration is not limited hereto. The determining apparatus 100 may determine a trigger condition for a vehicle other than the vehicles C.

Here, although a case has been described in which the determining apparatus 100 determines a pattern of a trigger condition having a relatively high evaluation without limiting the type of region, season, period, etc. in which a vehicle included in plural vehicle groups travels, configuration is not limited hereto. For example, the determining apparatus 100 may separately determine a pattern of trigger condition having a relatively high evaluation when applied to plural vehicle groups traveling in an urban area and a pattern of a trigger condition having a relatively high evaluation when applied to plural vehicle groups traveling in a rural area. Similarly, the determining apparatus 100 may determine, for both winter and busy seasons, a pattern of a trigger condition having a relatively high evaluation when applied to plural vehicle groups. Similarly, the determining apparatus 100 may determine, for both before noon and after noon in a single day, a pattern of a trigger condition having a relatively higher evaluation when applied to plural vehicle groups.

The determining apparatus 100 may use, as a vehicle group to which a pattern candidate of a trigger condition is to be applied, a vehicle group to which a pattern of a trigger condition has been applied for a predetermined period. As a result, the determining apparatus 100 does not apply a pattern candidate of a trigger condition to a vehicle group to which a pattern of a trigger condition has not been applied and that has a high possibility of preventing an occurrence of an accident irrespective of the pattern of a trigger condition applied. As a result, the determining apparatus 100 may improve the accuracy of verifying whether a pattern candidate of a trigger condition has a high or low possibility of preventing an occurrence of a traffic accident.

Here, although a case has been described in which the determining apparatus 100 determines a trigger condition for performing control in the vehicles C whereby an occurrence of a traffic accident may be prevented or the burden on a passenger of the vehicles C may be reduced, configuration is not limited hereto. For example, the determining apparatus 100 may determine a trigger condition for performing control in the vehicles C whereby the efficiency of avoiding congestion may be enhanced. In particular, the determining apparatus 100 evaluates a pattern of a trigger condition based on the time taken for the vehicles C to reach a destination after the pattern of a trigger condition is applied to a vehicle group to determine a pattern of a trigger condition for performing control in the vehicles C.

A pattern candidate of a trigger condition may include a pattern whose application to any of the vehicle groups up this time is desirable. In the description hereinafter, a pattern whose application to any of the vehicle groups up to this time may be indicated as a “fixed pattern”. Further, a pattern candidate of a trigger condition may include a pattern subject to verification of whether application to any of the vehicle groups up to this time is desirable. In the description hereinafter, a pattern subject to verification of whether application to any of the vehicle groups this time is desirable may be indicated as a “verification-subject pattern”.

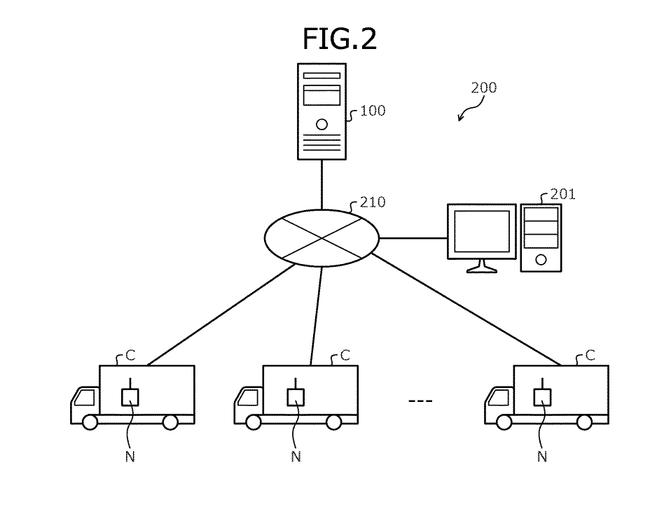

An example of an operation support system 200 according to the embodiment and to which the trigger condition determining method depicted in FIG. 1 is applied is described with reference to FIG. 2.

FIG. 2 is a diagram depicting an example of the operation support system 200 according to the embodiment. In FIG. 2, the operation support system 200 includes the determining apparatus 100, the plural vehicles C, and a client apparatus 201. The determining apparatus 100, the plural vehicles C, and the client apparatus 201 are connected by a network 210. The network 210 is, for example, a local area network (LAN), a wide area network (WAN), the Internet, etc.

As depicted in FIG. 1, the determining apparatus 100 may collect the travel information R of the plural vehicles C. The determining apparatus 100 determines a condition for performing control in the vehicles C according to driving operation of the vehicles C, based on the collected travel information R. As a result, the determining apparatus 100 may prevent an occurrence of a traffic accident.

The plural vehicles C are each equipped with an onboard vehicular apparatus N. The plural vehicles C may be vehicles owned by different companies and/or organizations. The onboard vehicular apparatus N is a computer configured to detect the travel information R of the vehicle C on which the onboard vehicular apparatus N is equipped. The onboard vehicular apparatus N transmits the detected travel information R to the determining apparatus 100, via the network 210. As a result, the onboard vehicular apparatus N may cause the determining apparatus 100 to accumulate the travel information R. Further, the onboard vehicular apparatus N receives a pattern of a trigger condition from the determining apparatus 100. The onboard vehicular apparatus N performs control in the vehicle C thereof, when the received pattern of a trigger condition is satisfied. As a result, the onboard vehicular apparatus N may prevent an occurrence of a traffic accident.

The client apparatus 201 is a computer configured to receive operation input from a user of the client apparatus 201 whereby a pattern candidate of a trigger condition is input to the client apparatus 201. The client apparatus 201 transmits the input pattern candidate of a trigger condition to the determining apparatus 100, via the network 210. As a result, the client apparatus 201 may set the pattern candidate of a trigger condition as a verification-subject pattern in the determining apparatus 100. Further, the client apparatus 201 receives the pattern of a trigger condition determined by the determining apparatus 100, via the network 210. The client apparatus 201 outputs the received pattern of the trigger condition. As a result, the client apparatus 201 may notify the user of the client apparatus 201 of the pattern of the trigger condition.

Configuration of the operation support system 200 in this manner provides an operation support service from the manager of the determining apparatus 100 to a manager of the vehicles C. The operation support service is a service for preventing an occurrence of a traffic accident based on the travel information R of the vehicle C and is provided by the determining apparatus 100. Here, the manager of the determining apparatus 100 may have different contracts with each of the managers of the plural vehicles C. The manager of the determining apparatus 100 may change the contents of the operation support service provided to each of the managers of the plural vehicles C, depending on the contents of the contract with each of the managers of the plural vehicles C.

For example, the manager of the determining apparatus 100 may change a trigger condition applied to the vehicle C depending on the contents of the contract. In particular, the manager of the determining apparatus 100 may enter with the manager of the vehicle C, a contract to preferably apply a pattern of a trigger condition having a relatively high possibility of preventing a traffic accident, for an additional fee from the manager of the vehicle C. Further, the manager of the determining apparatus 100 may enter with the manager of the vehicle C, a contract to guarantee application of a pattern of a trigger condition for which improvement is detected, for an additional fee from the manager of the vehicle C.

Further, when a trigger condition is satisfied, the manager of the determining apparatus 100 may change whether to give notification in the vehicle C or to perform control of the travel of the vehicle C such as reducing the speed of the vehicle C, depending on the contents of the contract entered. As a result, the manager of the determining apparatus 100 may enter a contract that matches the needs of the manager of the vehicle C. The manager of the determining apparatus 100 may prevent an occurrence of a traffic accident involving the vehicle C according to the needs of the manager of the vehicle C.

Here, although a case has been described in which the determining apparatus 100 and the client apparatus 201 are different apparatuses, configuration is not limited hereto. For example, the determining apparatus 100 may be integrated with the client apparatus 201. Here, although a case has been described in which the client apparatus 201 is a single apparatus, configuration is not limited hereto. For example, two or more of the client apparatuses 201 may be included.

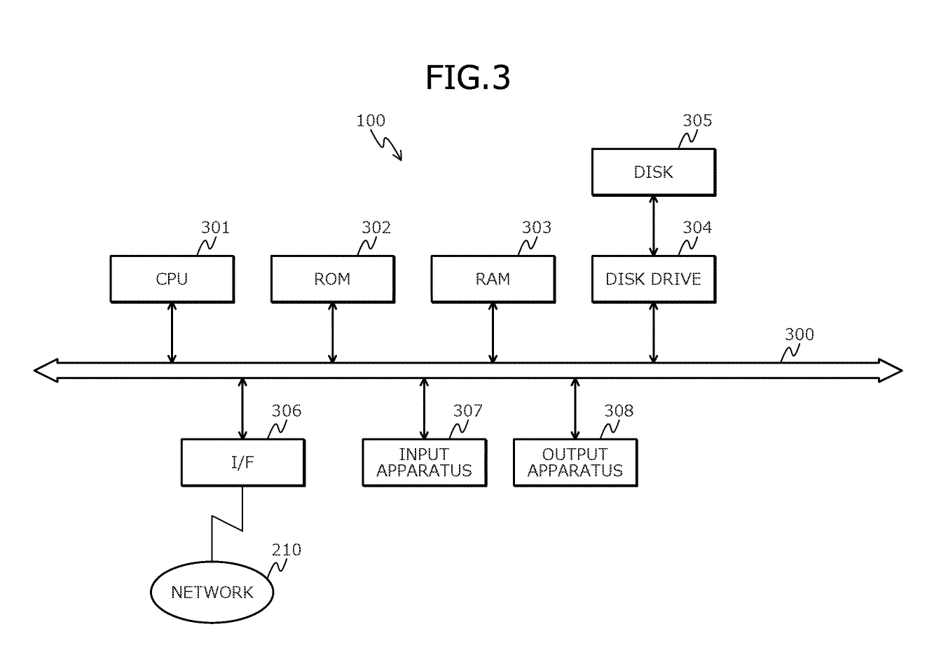

An example of hardware of the determining apparatus 100 included in the operation support system 200 depicted in FIG. 2 is described with reference to FIG. 3.

FIG. 3 is a block diagram of one example of hardware of the determining apparatus 100. In FIG. 3, the determining apparatus 100 includes a central processing unit (CPU) 301, read-only memory (ROM) 302, and random access memory (RAM) 303. The determining apparatus 100 further includes a disk drive 304, a disk 305, an interface (I/F) 306, an input apparatus 307, and an output apparatus 308.

The CPU 301, the ROM 302, the RAM 303, the disk drive 304, the I/F 306, the input apparatus 307, and the output apparatus 308 are connected by a bus 300. The determining apparatus 100 is, for example, a server, notebook-type computer, a desktop computer, or the like.

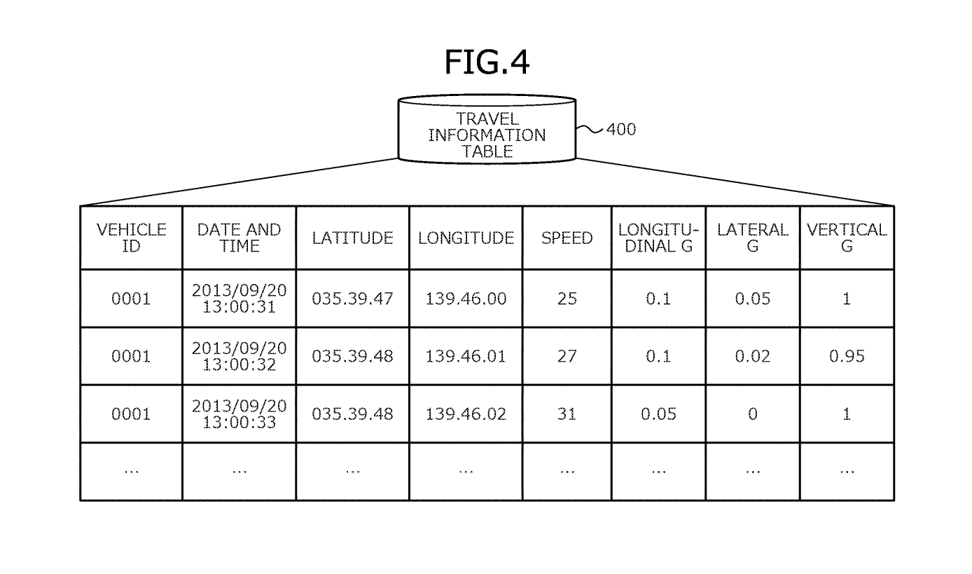

Here, the CPU 301 governs overall control of the determining apparatus 100. The ROM 302 stores various programs such as a boot program. The RAM 303 is used as work area of the CPU 301. Further, the RAM 303 stores various types of data obtained by execution of the programs. The RAM 303 may further store various types of tables such as those depicted in FIGS. 4 to 9 described hereinafter.

The disk drive 304, under the control of the CPU 301, controls the reading and writing of data with respect to the disk 305. The disk 305 stores data written thereto under the control of the disk drive 304. In place of the RAM 303, the disk 305 may store various tables described hereinafter with reference to FIGS. 4 to 9. The disk 305 is, for example, a magnetic disk or an optical disk.

The I/F 306 is connected to the network 210 through a communications line and is connected to other apparatuses via the network 210. The I/F 306 administers an internal interface with the network 210 and controls the input and output of data from an external apparatus. A modem, a LAN adapter, or the like may be adopted as the I/F 306, for example.

The input apparatus 307 is an interface that performs various types of data input by user operation of a keyboard, a touch panel, etc. The input apparatus 307 may be a mouse, a scanner, etc. The output apparatus 308 is an interface that outputs data in response to an instruction of the CPU 301. The output apparatus 308 is, for example, is a display that displays a cursor, icons, and toolboxes in addition to data such as documents, images, and functional information. The output apparatus 308 may be a printer.

The determining apparatus 100 may be configured omitting at least any one of the input apparatus 307 and the output apparatus 308. The determining apparatus 100 may further include a solid state drive (SSD) and semiconductor memory. The determining apparatus 100 may have a SSD and semiconductor memory in place of the disk drive 304 and the disk 305.

An example of contents of a travel information table 400 is described with reference to FIG. 4. The travel information table 400 is implemented by, for example, a storage region such as the ROM 302, the RAM 303, the disk 305 depicted in FIG. 3, or the like.

FIG. 4 is a diagram depicting an example of the contents of the travel information table 400. As depicted in FIG. 4, the travel information table 400 has a date and time field, a latitude field, a longitude field, a speed field, a longitudinal G field, a lateral G field, and a vertical G field associated with a vehicle ID field. The travel information table 400 stores records by a setting of information into the fields for each vehicle C.

The vehicle ID field stores identification information of the vehicle C. The date and time field stores date and time information such as a year, month, day, hour, minute, seconds, etc. The latitude field stores a latitude value of a coordinate in a geographic coordinate system corresponding to a position of the vehicle C indicated by the identification information in the vehicle ID field, on the date and time in the date and time field. The longitude field stores a longitude value of a coordinate in a geographic coordinate system corresponding to a position of the vehicle C indicated by the identification information in the vehicle ID field, on the date and time in the date and time field. The speed field stores the speed of the vehicle C indicated by the identification information in the vehicle ID field, on the date and time in the date and time field. The unit of the speed is, for example, km/h.

The longitudinal G field stores the longitudinal acceleration of the vehicle C indicated by the identification information in the vehicle ID field, on the date and time in the date and time field. The unit of the acceleration is, for example, m/ŝ2. The lateral G field stores the lateral acceleration of the vehicle C indicated by the identification information in the vehicle ID field, on the date and time in the date and time field. The vertical G field stores the vertical acceleration of the vehicle C indicated by the identification information in the vehicle ID field, on the date and time in the date and time field.

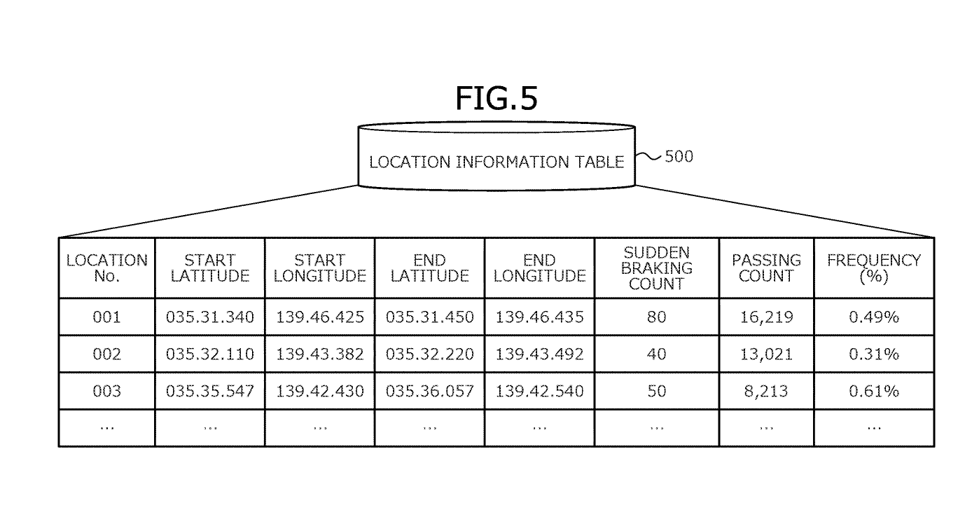

The travel information table 400 is created by the determining apparatus 100, based on the travel information R received from the onboard vehicular apparatuses N. The travel information table 400 enables the determining apparatus 100 identify a zone prone to sudden braking. An zone prone to sudden braking identified by the determining apparatus 100 is stored by, for example, a location information table 500 depicted in FIG. 5 described hereinafter. Further, the travel information table 400 enables the determining apparatus 100 to calculate an evaluation value of a pattern of a trigger condition.

An example of contents of the location information table 500 is described with reference to FIG. 5. The location information table 500 is implemented by, for example, a storage region such as the ROM 302, the RAM 303, the disk 305 depicted in FIG. 3, or the like.

FIG. 5 is a diagram depicting an example of the contents of the location information table 500. As depicted in FIG. 5, the location information table 500 has a start latitude field, a start longitude field, an end latitude field, an end longitude field, a sudden braking count field, a passing count field, and a frequency field associated with a location number (No.) field. The location information table 500 stores records by a setting of information into the fields for each location having a rectangular shape and a predetermined size. The rectangular shape is, for example, a rectangle 90 m in a latitudinal direction and 75 m in a longitudinal direction.

The location No. field stores identification information of location. The start latitude field stores the latitude of a starting point of a rectangular region indicated by the identification information in the location No. field. The starting point is, for example, any one of the vertices of the rectangular region. The start longitude field stores the longitude of the starting point of the rectangular region indicated by the identification information in the location No. field.

The end latitude field stores the latitude of an ending point of the rectangular region that is the location indicated by the identification information in the location No. field. The ending point is, for example, the vertex opposing the starting point of the rectangular region, among the vertices of the rectangular region. The end longitude field stores the longitude of the ending point of the rectangular region that is the location indicated by the identification information in the location No. field.

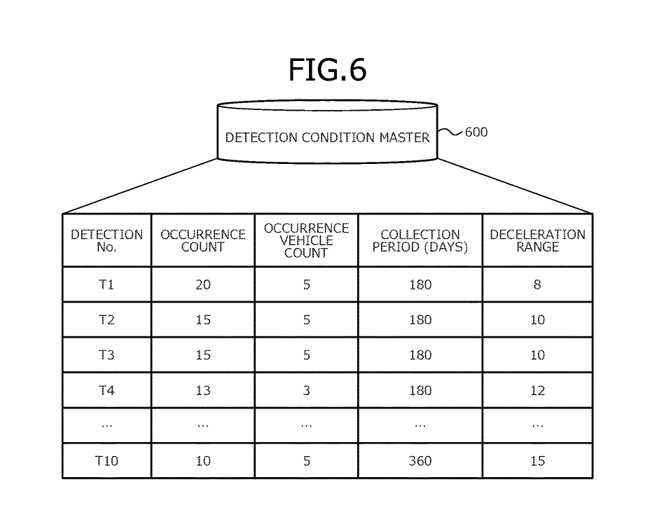

The sudden braking count field stores the number of times that the vehicle C braked suddenly in the rectangular region that is the location indicated by the identification information in the location No. field. Sudden braking is a state in which, for example, acceleration in the rearward direction is greater than the value of a deceleration range field of a detection condition master 600 depicted in FIG. 6 and described hereinafter. The passing count field stores a count of the vehicles C passing through the rectangular region that is the location indicated by the identification information in the location No. field. The frequency field stores a ratio of the sudden braking count of the sudden braking count field to the passing vehicle count in the passing count field.

The location information table 500 is created by the determining apparatus 100, based on the travel information table 400 and the detection condition master 600 in FIG. 6 described hereinafter. The determining apparatus 100 may create the location information table 500 for each detection condition of the detection condition master 600 in FIG. 6. The location information table 500 enables the determining apparatus 100 to identify a notification place where notification is to be given in the vehicle C. A notification place identified by the determining apparatus 100 may be stored by, for example, a notification place information table.

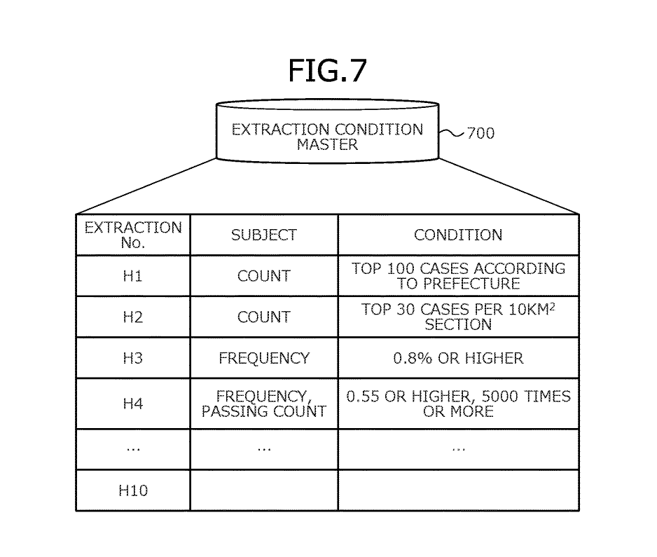

The notification place information table is, for example, a table extracted from and storing some of the records of the location information table 500, based on an extraction condition master 700 depicted in FIG. 7 and described hereinafter. Contents of the notification place information table are identical to the contents of the location information table 500 and therefore, description thereof is omitted herein.

An example of contents of the detection condition master 600 is described with reference to FIG. 6. The detection condition master 600 is implemented by, for example, a storage region such as the ROM 302, the RAM 303, the disk 305 depicted in FIG. 3, or the like.

FIG. 6 is a diagram depicting an example of the contents of the detection condition master 600. As depicted in FIG. 6, the detection condition master 600 has an occurrence count field, an occurrence vehicle count field, a collection period field, and the deceleration range field associated with the detection No. field. The detection condition master 600 stores records by a setting of information into the fields for each detection condition for detecting a zone prone to sudden braking.

The detection No. field stores identification information of a detection condition. The occurrence count field stores a count that is used as a threshold when a zone prone to sudden braking is detected based on whether the sudden braking count is greater than a threshold. The occurrence vehicle count field stores a value that is used as the threshold when a zone prone to sudden braking is detected based on whether a count of the vehicles C that have braked suddenly is greater than a threshold. The collection period field stores the period of collection of the travel information R used when a zone prone to sudden braking is detected. The deceleration range field stores a value that is used as the threshold when a zone prone to sudden braking is detected based on whether the acceleration of the vehicle C in the rearward direction is exceeds than a threshold.

The detection condition master 600 is input to the determining apparatus 100 by the manager of the determining apparatus 100 and created by the determining apparatus 100. The determining apparatus 100, for example, when the manager of the determining apparatus 100 inputs a combination of a detection condition expressing a verification-subject pattern and the detection condition, the detection condition is set into the detection condition master 600. The detection condition master 600 enables the determining apparatus 100 to detect a zone prone to sudden braking.

An example of contents of the extraction condition master 700 is described with reference to FIG. 7. The extraction condition master 700 is implemented by, for example, a storage region such as the ROM 302, the RAM 303, the disk 305 depicted in FIG. 3, or the like.

FIG. 7 is a diagram depicting an example of the contents of the extraction condition master 700. As depicted in FIG. 7, the extraction condition master 700 has a subject field and a condition field associated with an extraction No. field. The extraction condition master 700 stores records by a setting of information into the fields for each extraction condition for extracting a notification place.

The extraction No. field stores identification information of an extraction condition. The subject field stores a name of an element used when a notification place is extracted. “Count” in the subject field represents, for example, the sudden braking count. The condition field stores a condition used when a notification place is extracted based on the element indicated by the name in the subject field. “Top 100 cases according to prefecture” in the condition field indicates, for example, for each prefecture, a condition of extracting as a notification place, locations of the top 100 cases of the element “sudden braking count”.

The extraction condition master 700 is input to the determining apparatus 100 by the manager of the determining apparatus 100 and created by the determining apparatus 100. The determining apparatus 100, for example, when a combination of an extraction condition and a detection condition expressing a verification-subject pattern are input by the manager of the determining apparatus 100, sets the extraction condition in the extraction condition master 700. The extraction condition master 700 enables the determining apparatus 100 to detect a notification place. By a combination of a detection condition of the detection condition master 600 and an extraction condition of the extraction condition master 700, a pattern of a trigger condition may be expressed.

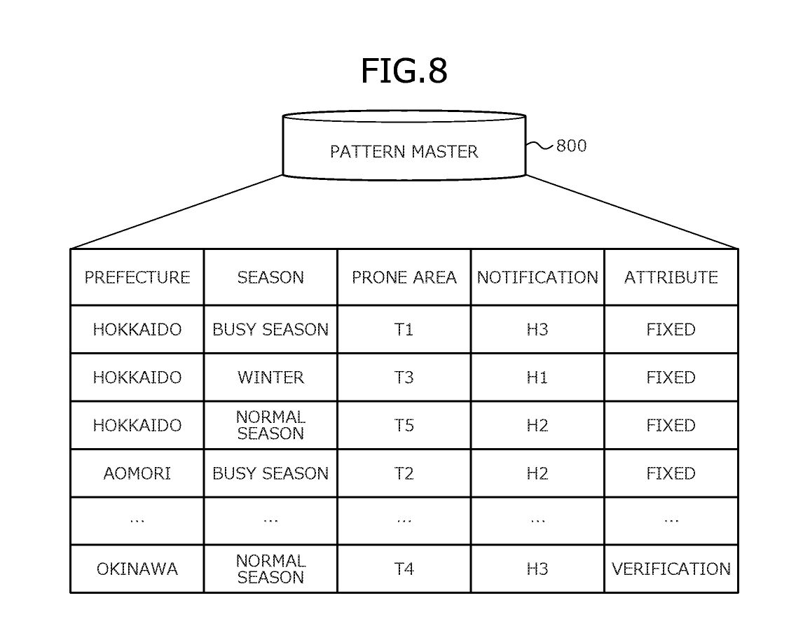

An example of contents of a pattern master 800 is described with reference to FIG. 8. The pattern master 800 is implemented by, for example, a storage region such as the ROM 302, the RAM 303, the disk 305 depicted in FIG. 3, or the like.

FIG. 8 is a diagram depicting an example of the contents of the pattern master 800. As depicted in FIG. 8, the pattern master 800 has a season field, a prone area field, a notification field, and an attribute field associated with a prefecture field. The pattern master 800 stores records by a setting of information in the fields for each prefecture.

The prefecture field stores a prefecture. The season field stores a season. A busy season is a season when the business of the manager of the vehicle group is busy and is preset. A normal season is a season when the business of the manager of the vehicle group is not busy and is preset. Winter is a period affected by snow. The prone area field stores identification information of a condition used as a detection condition for detecting a zone prone to sudden braking in the prefecture of the prefecture field during the season of the season field. The notification field stores identification information of a condition used as an extraction condition for extracting a notification place in the prefecture of the prefecture field, during the season of the season field.

The attribute field stores whether a pattern of a trigger condition that is a combination of the detection condition indicated by the identification information in the prone area field and the extraction condition indicated by the identification information in the notification field is a fixed pattern or a verification-subject pattern. “Fixed” in the attribute field indicates a fixed pattern. “Verification” in the attribute field indicates a verification-subject pattern.

The pattern master 800 is created by the determining apparatus 100. Further, the pattern master 800 is created by a pattern being added by the determining apparatus 100. The pattern master 800 enables the determining apparatus 100 to identify a fixed pattern and a verification-subject pattern. The pattern master 800 enables different patterns to be associated with locations having different road conditions such as urban areas and rural areas. Further, the pattern master 800 enables different patterns to be associated with seasons having different business states, travel states, road conditions, etc. such as a busy season and winter, which is affected by snow.

The pattern master 800 may further have a vehicle type field. The vehicle type field stores the type of the vehicle C. As a result, the pattern master 800 may associate different patterns for vehicles C of different traveling performance such as motorcycles, economy cars, trucks, etc.

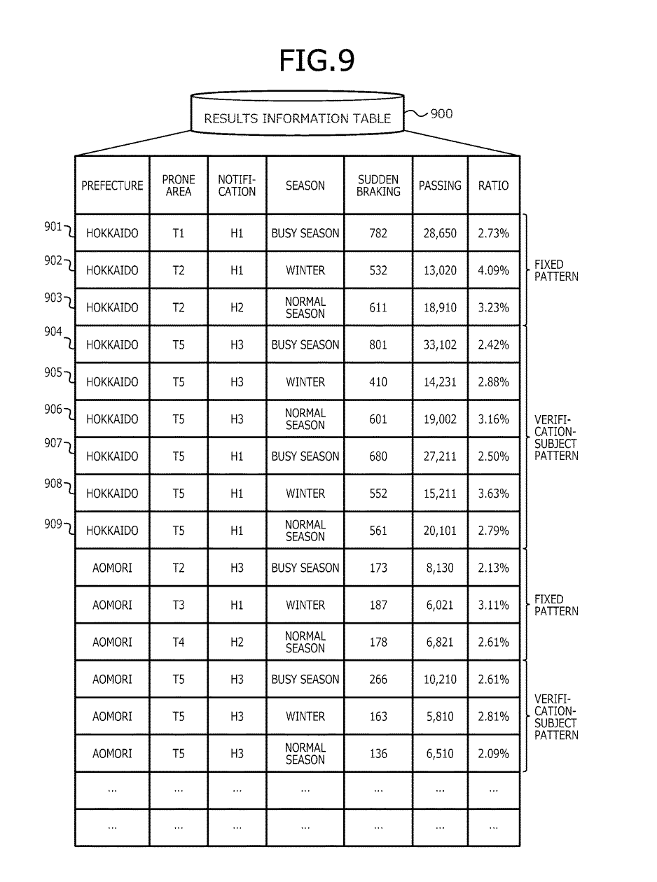

An example of contents of a results information table 900 is described with reference to FIG. 9. The results information table 900 is implemented by, for example, a storage region such as the ROM 302, the RAM 303 and the disk 305 depicted in FIG. 3, or the like.

FIG. 9 is a diagram depicting an example of the contents of the results information table 900. As depicted in FIG. 9, the results information table 900 has a prone area field, a notification field, a season field, a sudden braking field, a passage field, and a ratio field associated with a prefecture field. The results information table 900 stores records by a setting of information to the fields for each prefecture.

The prefecture field stores a prefecture. The season field stores a season. The prone area field stores identification information of a condition used as a detection condition for detecting a zone prone to sudden braking in the prefecture in the prefecture field during the season in the season field. The notification field stores identification information of a condition used as an extraction condition to extract a notification place in the prefecture in the prefecture field during the season in the season field.

The sudden braking field stores a count of sudden braking by vehicles C in the prefecture in the prefecture field during the season in the season field. The passage field stores a count of vehicles C that passed through the prefecture in the prefecture field during the season in the season field. The ratio field stores a ratio of the sudden braking count in the sudden braking field to the count of vehicles C that passed through in the passage field.

The results information table 900 is created by the determining apparatus 100 based on the travel information table 400 and the pattern master 800. The determining apparatus 100 sets the contents of the notification field and the prone area field of the pattern master 800 expressing a pattern into, for example, the prone area field and the notification field of the results information table 900. Further, based on the travel information table 400, the determining apparatus 100 extracts and sets into the sudden braking field, the sudden braking count of the vehicles c to which is applied, the pattern expressed by the combination of the notification field and the prone area field in the prefecture in the prefecture field during the season in the season field.

Similarly, based on the travel information table 400, the determining apparatus 100 extracts and sets into the passage field, the count of passing vehicles to which is applied, the pattern expressed by the combination of the notification field and the prone area field in the prefecture in the prefecture field during the season in the season field. Further, the determining apparatus 100 calculates and sets into the ratio field, the ratio of the sudden braking count in the sudden braking field to the count of passing vehicles C in the passage field. The results information table 900 enables the determining apparatus 100 evaluate each pattern. The determining apparatus 100, for example, gives a higher evaluation to a pattern for which the value of the ratio field is smaller.

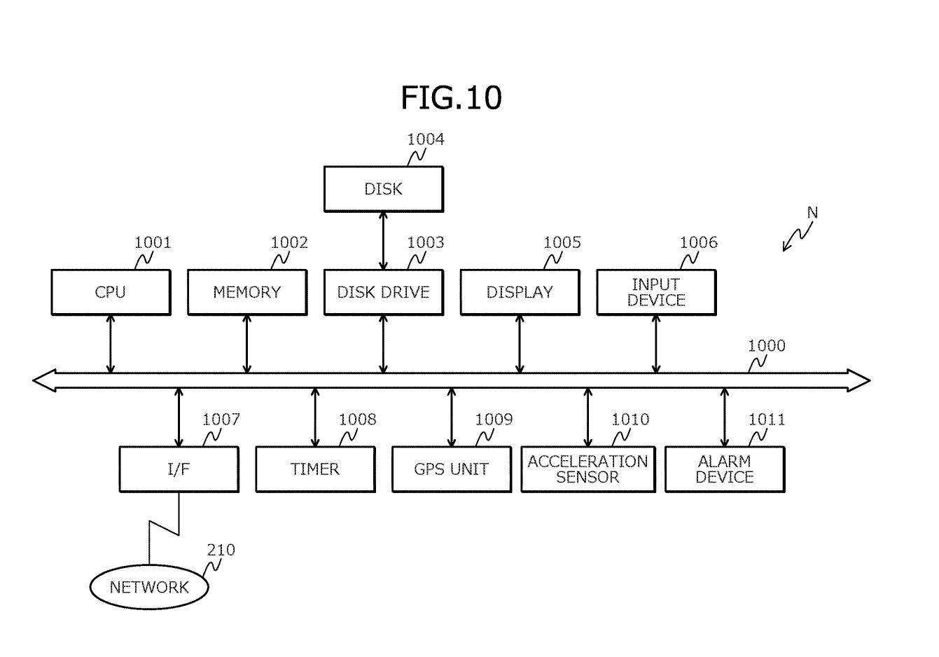

An example of hardware of the onboard vehicular apparatus N included in the operation support system 200 depicted in FIG. 2 is described with reference to FIG. 10.

FIG. 10 is a block diagram of an example of hardware of the onboard vehicular apparatus N. In FIG. 10, the onboard vehicular apparatus N includes a CPU 1001, a memory 1002, a disk drive 1003, and a disk 1004. The onboard vehicular apparatus N further includes a display 1005, an input device 1006, an I/F 1007, a timer 1008, a global positioning system (GPS) unit 1009, an acceleration sensor 101, and an alarm device 1011.

The components 1001 to 1003, and 1005 to 1011 are connected by a bus 1000. The onboard vehicular apparatus N is, for example, a car navigation apparatus, a smartphone, a personal digital assistant (PDA), a tablet terminal, or the like.

Here, the CPU 1001 governs overall control of the onboard vehicular apparatus N. The memory 1002 includes, for example, ROM, RAM, and flash ROM. In particular, the flash ROM and the ROM store various programs such as a boot program, and the RAM is used as a work area of the CPU 1001. A program stored in the memory 1002 is loaded onto the CPU 1001 whereby an encoded process is executed by the CPU 1001.

The disk drive 1003, under the control of the CPU 1001, controls the reading and writing of data to the disk 1004. The disk 1004 stores data written thereto under the control of the disk drive 1003. The disk 1004 may be, for example, a magnetic disk or an optical disk.

The display 1005 displays a cursor, icons, and toolboxes in addition to data such as documents, images, function information, and the like. The display 1005 is, for example, a cathode ray tube (CRT), a thin film transistor (TFT) liquid crystal display, a plasma display, or the like. The input device 1006 has keys for inputting various instructions, numerals, and text, and performs input of data. Further, the input device 1006 may be a touch panel type input pad, numeric pad, etc.

The I/F 1007 is connected to the network 210 through communications line and is connected to other apparatuses (for example, the determining apparatus 100 depicted in FIG. 2) via the network 210. The I/F 1007 administers an internal interface with the network 210 and controls the input and output of data from an external apparatus.

The timer 1008 measures time such as years, months, days, hours, minutes, seconds, etc. The GPS unit 1009 receives radio waves (GPS signals) from a GPS satellite and outputs position information indicating a position of the onboard vehicular apparatus N (the vehicle C). The position information of the onboard vehicular apparatus N (the vehicle C) is, for example, information identifying one point in a geographic coordinate system such as latitude/longitude, altitude, etc.

The acceleration sensor 1010 detects acceleration in 3 axial directions including a longitudinal direction, a lateral direction, and a vertical direction of the onboard vehicular apparatus N (the vehicle C). The acceleration sensor 1010, for example, detects longitudinal acceleration as a negative value when a force in a rearward direction is placed in the vehicle C and detects longitudinal acceleration as a positive value when a force in a forward direction is placed in the vehicle C. Further, the acceleration sensor 1010 detects vertical acceleration as a positive value when the vehicle C is moving in an upward direction and detects vertical acceleration as a negative value when the vehicle C is moving in a downward direction. Further, the acceleration sensor 1010 detects lateral acceleration as positive value when the vehicle C is moving in a rightward direction and detects lateral acceleration as negative value when the vehicle C is moving in a leftward direction. Correspondence of positive/negative values and the direction of acceleration detected by the acceleration sensor 1010 may differ from the examples described above.

The alarm device 1011 performs control in the vehicle C according to the driving operation, when the vehicle C satisfies a trigger condition. The alarm device 1011, for example, gives a message in the vehicle C when the vehicle C satisfies a trigger condition. The alarm device 1011 may control the driving operation in the vehicle C, when the vehicle C satisfies a trigger condition.

The onboard vehicular apparatus N may be configured omitting, for example, the timer 1008, the GPS unit 1009, and the acceleration sensor 1010. In this case, the onboard vehicular apparatus N may obtain, for example, the position, date, acceleration of the vehicle C, etc. from a sensor equipped on the vehicle C. Further, the onboard vehicular apparatus N may further have a SSD and semiconductor memory. Further, the onboard vehicular apparatus N may have a SSD and semiconductor memory in place of the disk drive 1003 and the disk 1004.

An example of hardware of the client apparatus 201 is, for example, identical to the example of hardware of the determining apparatus 100. Therefore, description of an example of hardware of the client apparatus 201 is omitted herein. The client apparatus 201 is, for example, notebook-type computer, a desktop computer, or the like.

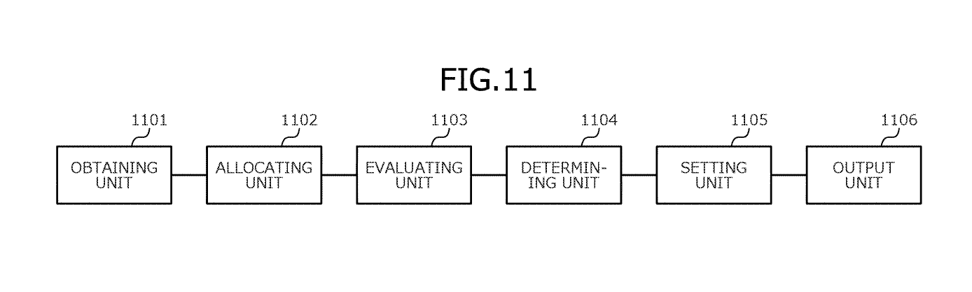

An example of functional configuration of the determining apparatus 100 is described with reference to FIG. 11.

FIG. 11 is a block diagram of an example of functional configuration of the determining apparatus 100. The determining apparatus 100 includes an obtaining unit 1101, an allocating unit 1102, an evaluating unit 1103, a determining unit 1104, a setting unit 1105, and an output unit 1106 as functions constituting a control unit.

The obtaining unit 1101 obtains the travel information R of each vehicle C included in plural vehicle groups. The obtaining unit 1101, for example, obtains information such as driving operation contents of the vehicle C, the speed and acceleration of the vehicle C, and the position of the vehicle C as the travel information R of the vehicle C, from the onboard vehicular apparatus N equipped on each vehicle C included in the plural vehicle groups. As a result, the obtaining unit 1101 may obtain the travel information R used in evaluating a pattern of a trigger condition.

The obtaining unit 1101 may obtain a verification-subject pattern as a pattern candidate of a trigger condition. The obtaining unit 1101, for example, receives from the client apparatus 201, a combination of an extraction condition and a detection condition expressing a verification-subject pattern. As a result, the obtaining unit 1101 may output a verification-subject pattern to the allocating unit 1102.

The obtaining unit 1101 is implemented by, for example, executing on the CPU 301, a program stored a storage apparatus such as the ROM 302, the RAM 303, the disk 305 depicted in FIG. 3, or the like, or may be implemented by the I/F 306. The obtained travel information R, for example, is stored to a storage region such as the RAM 303, the disk 305, or the like.

The allocating unit 1102, when plural pattern candidates of a trigger condition are present, distributes and allocates each of the pattern candidates to plural vehicle groups. A trigger condition is a condition for performing control in a vehicle C according to the driving operation. A trigger condition, for example, is a condition identifying a dangerous driving-operation occurring point. A dangerous driving-operation occurring point, for example, is a zone prone to sudden braking, a zone prone to rapid acceleration, a zone prone to abrupt steering actions, a zone prone to hazard light use, a zone prone to door opening and closing, and the like. Further, a trigger condition may be a condition identifying a distance to a dangerous driving-operation occurring point.

Control in a vehicle C according to the driving operation is control to urge a passenger of the vehicle C to perform a driving operation to prevent an occurrence of a traffic accident involving the vehicle C, avoid congestion, or reduce the burden of a passenger of the vehicle C. Control in the vehicle C, for example, is notification given in the vehicle C. Further, control in the vehicle C may be control of the travel of the vehicle C such as reducing the speed of the vehicle C. A pattern candidate of a trigger condition may be a fixed pattern or may be a verification-subject pattern obtained by the obtaining unit 1101.

The allocating unit 1102, for example, when there are plural patterns to be pattern candidates of a trigger condition, allocates each of the patterns to each of the plural vehicle groups during a predetermined test period. In particular, when the patterns P1 to P3 are to be pattern candidates of a trigger condition, the allocating unit 1102 allocates each of the patterns P1 to P3 to each of the plural vehicle groups G1 to G3 for two weeks. As a result, the allocating unit 1102 allocates the patterns to the vehicle groups, enabling verification of whether an occurrence of a traffic accident involving a vehicle group allocated a pattern could be prevented.

Further, the allocating unit 1102, for example, may allocate plural patterns to one vehicle group, for plural sub-periods into which the predetermined test period is divided. In particular, when the patterns P1 to P5 are to be pattern candidates of a trigger condition, the allocating unit 1102 allocates to the vehicle group G1, the pattern P1 for 7 days, the pattern P2 for 5 days, and the pattern P5 for 2 days. As a result, of the plural vehicle groups, when a vehicle group for which a traffic accident is relatively likely to occur and a vehicle group for which a traffic accident is relatively unlikely to occur are present, the allocating unit 1102 may suppress decreases in the accuracy of verification.

After application of each of the trigger conditions and after the predetermined test period elapses, the allocating unit 1102 returns the applied trigger condition to the trigger condition before the application of each of the trigger conditions. After the predetermined test period elapses from the application of each of the pattern candidates of a trigger condition, the allocating unit 1102, for example, returns the trigger condition to be applied to each of the plural vehicle groups to the trigger condition used before the application of the pattern candidates of a trigger condition. As a result, from a verification-subject pattern under verification of the possibility of preventing an occurrence of a traffic accident, the allocating unit 1102 may return the pattern of a trigger condition to be applied to a vehicle group to the originally applied pattern having a high possibility of preventing an occurrence of a traffic accident. Therefore, the allocating unit 1102 may enhance the safety of the vehicle group.

The allocating unit 1102 is implemented by, for example, executing on the CPU 301, a program stored in a storage apparatus such as the ROM 302, the RAM 303, the disk 305 depicted in FIG. 3, or the like, or may be implemented by the I/F 306. Allocation results, for example, are stored to a storage region such as the RAM 303, the disk 305, or the like.

Based on a change in the travel information R before application and after application of a trigger condition corresponding to each of the pattern candidates applied by the allocating unit 1102, the evaluating unit 1103 evaluates a trigger condition corresponding to each of the pattern candidates allocated by the allocating unit 1102. Based on the travel information R obtained by the obtaining unit 1101, the evaluating unit 1103, for example, evaluates each of the patterns P1 to P3 allocated by the allocating unit 1102.

In particular, the evaluating unit 1103 calculates for each of the patterns P1 to P3, a sudden braking count before and after application based on the acceleration of the vehicles C included in the travel information R. The determining apparatus 100 calculates an evaluation value for each of the patterns P1 to P3 so that the evaluation value of the patterns P1 to P3 is higher, the lower the sudden braking count is after application of the pattern P1 to P3.

Further, the evaluating unit 1103 may use the sudden braking count itself as an evaluation value. In this case, the lower the evaluation value is, the better the evaluation is. Hereinafter, a case is described in which the evaluating unit 1103 calculates an evaluation value to be higher, the lower the sudden braking count is. As a result, the evaluating unit 1103 may obtain an index of whether each of the plural patterns has a high or low possibility of preventing an occurrence of a traffic accident.

The evaluating unit 1103, for example, is implemented by executing on the CPU 301, a program stored in a storage apparatus such as the ROM 302, the RAM 303, the disk 305 depicted in FIG. 3, or the like, or by the I/F 306. Evaluation results, for example, are stored to a storage region such as the RAM 303, the disk 305, or the like.

The determining unit 1104 determines, as a trigger condition to be applied in a service provided to the plural vehicle groups among the plural trigger conditions, a trigger condition having a relatively high evaluation or satisfying a predetermined standard. A service provided to the plural vehicle groups is a service to prevent an occurrence of a traffic accident involving the plural vehicle groups.

The determining unit 1104, for example, determines the pattern having the highest evaluation value calculated by the evaluating unit 1103 to be the pattern of a trigger condition in a service provided to the plural vehicle groups. Further, the determining unit 1104 may determine a pattern for which the evaluation value calculated by the evaluating unit 1103 is a threshold or higher to be the pattern of a trigger condition in a service provided to the plural vehicle groups. As a result, the determining unit 1104 may determine among pattern candidates for a trigger condition, a pattern having a high possibility of preventing an occurrence of a traffic accident to be the pattern of a trigger condition to be applied in a service provided to the plural vehicle groups.

The determining unit 1104 determines among the plural trigger conditions, a trigger condition having a relatively low evaluation or not satisfying a predetermined standard, to be a trigger condition that is not to be applied in a service provided to the plural vehicle groups. The determining unit 1104, for example, determines the pattern having the lowest evaluation calculated by the evaluating unit 1103 to be a pattern of a trigger condition that is not to be applied in a service provided to the plural vehicle groups. Further, the determining unit 1104 may determine a pattern for which the evaluation value calculated by the evaluating unit 1103 is lower than a threshold to be a pattern of a trigger condition that is not to be applied in a service provided to the plural vehicle groups. As a result, the determining unit 1104 may determine among the pattern candidates of a trigger condition, a pattern having a low possibility of preventing an occurrence of a traffic accident to be a pattern of a trigger condition that is not to be applied in a service provided to the plural vehicle groups.

The determining unit 1104, for example, is implemented by executing on the CPU 301, a program stored in a storage apparatus such as the ROM 302, the RAM 303, the disk 305 depicted in FIG. 3, or the like, or by the I/F 306. Determination results, for example, are stored to a storage region such as the RAM 303, the disk 305, or the like.

The setting unit 1105 applies to a vehicle group to which a service is provided under a predetermined contract, a trigger condition among plural trigger conditions and obtained by travel data that improved after application to another vehicle group as compared to before application. The predetermined contract, for example, is a contract to preferentially apply a pattern of a trigger condition having a relatively high possibility of preventing a traffic accident. In particular, the predetermined contract is a contract entered by a payment of an additional fee when a contract to provide an operation support service to a vehicle group is entered.

The setting unit 1105, for example, applies to the vehicle group, the pattern that has the highest evaluation value calculated by the evaluating unit 1103 among plural patterns including a fixed pattern and a verification-subject pattern and that is determined by the determining unit 1104 to be a pattern of a trigger condition to be applied in a service. As a result, the setting unit 1105 may change the contents of the operation support service provided to the manager of the vehicle group, depending on the contents of the contract entered with the manager of the vehicle group. The setting unit 1105 may further increase the possibility of preventing a traffic accident involving the vehicle group according to the needs of the manager with whom the predetermined contract is entered.

The setting unit 1105 applies to the vehicle group to which a service is to be provided under a contract to which a first contract is applied, a trigger condition that is selected from a trigger condition group to replace the current trigger condition and for which improvement is detected before and after application. The first contract, for example, is a contract to preferentially apply a pattern of a trigger condition having a relatively high possibility of preventing an occurrence of a traffic accident. In particular, the first contract is a contract entered by a payment of an additional fee when a contract to provide an operation support service to a vehicle group is entered.

The setting unit 1105, for example, applies to the vehicle group, the pattern that has the highest evaluation value calculated by the evaluating unit 1103 among verification-subject patterns and is determined by the determining unit 1104 to be a pattern of a trigger condition applied in a service. As a result, the setting unit 1105 may change the contents of the operation support service provided to the manager of the vehicle group, depending on the contents of the contract entered with the manager of the vehicle group. The setting unit 1105 may further increase the possibility of preventing a traffic accident involving the vehicle group according to the needs of the manager with whom the predetermined contract is entered.

The setting unit 1105 applies a trigger condition selected from among predetermined trigger conditions to a vehicle group to which a service is to be provided under a contract to which a second contract is not applied. The second contract, for example, is a contract to guarantee application of a trigger condition for which improvement has been detected. The setting unit 1105, for example, applies a verification-subject pattern obtained by the obtaining unit 1101 to a vehicle group to which a service is to be provided under a contract to which a second contract is not applied. As a result, the setting unit 1105 may allocate to a vehicle group, a verification-subject pattern that has not been verified in terms of having a high or low possibility of preventing an occurrence of a traffic accident.

The setting unit 1105, for example, is implemented by executing on the CPU 301, a program stored in a storage apparatus such as the ROM 302, the RAM 303, the disk 305 depicted in FIG. 3, or the like, or by the I/F 306.

The output unit 1106 outputs a pattern of a trigger condition. The output unit 1106, for example, displays on a display that is the output apparatus 308 or prints out at a printer that is the output apparatus 308, the pattern of a trigger condition determined by the determining unit 1104 as a pattern of a trigger condition to be applied in a service provided to plural vehicle groups. Further, the output unit 1106 may transmit to the client apparatus 201 via the I/F 306, the trigger condition determined by the determining unit 1104 as a pattern of a trigger condition to be applied in a service provided to plural vehicle groups the determining unit 1104.

Further, the output unit 1106 may store to the RAM 303, the disk 305, or the like, the trigger condition determined, by the determining unit 1104, as a pattern of a trigger condition to be applied in a service provided to plural vehicle groups. As a result, the output unit 1106 may notify the manager of the determining apparatus 100 or the manager of the client apparatus 201 of the pattern of a trigger condition determined by the determining unit 1104.

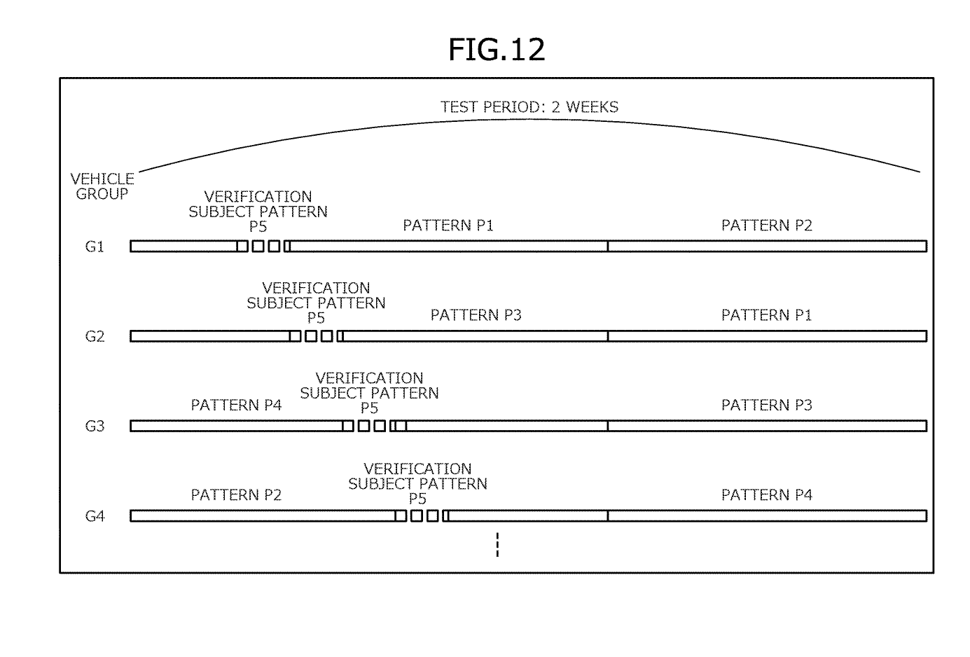

An example of determination of a trigger condition by the determining apparatus 100 is described with reference to FIGS. 12 to 15. First, description is given using FIG. 12.

FIG. 12 is a diagram depicting an example of allocation of pattern candidates of a trigger condition. In the example depicted in FIG. 12, the determining apparatus 100 allocates each pattern among plural patterns that are pattern candidates to 40,000 units of the vehicle C. Here, the 40,000 units of the vehicle C are separated into the plural vehicle groups G1 to G4 of 10,000 units each.

The determining apparatus 100 stores the patterns P1 to P5 as pattern candidates of a trigger condition. The patterns P1 to P4 are patterns that have been allocated to at least any one of the plural vehicle groups. In other words, the patterns P1 to P4 are fixed patterns. The pattern P5 is a pattern that is newly generated this time and that has not been allocated to any of the plural vehicle groups. In other words, the pattern P5 is a verification-subject pattern.

The determining apparatus 100 allocates each of the patterns P1 to P5 to each of the plural vehicle groups G1 to G4 for a predetermined test period. In FIG. 12, the test period is 2 weeks. The determining apparatus 100, for example, when allocating the patterns P1 to P5 to one of the plural vehicle groups G1 to G4, may divide the 2-week test period into plural sub-periods and allocate a different pattern for each sub-period. As a result, the determining apparatus 100 may suppress a decrease in the accuracy of verification when, among the plural vehicle groups, a vehicle group more prone to traffic accidents and/or a groups less prone to traffic accidents is present.

Further, the determining apparatus 100, when allocating the patterns P1 to P5 to any of the plural vehicle groups G1 to G4, may set the sub-period during which the pattern P5, which is to be verified, is allocated to be shorter than a sub-period during which another pattern is allocated. As a result, the determining apparatus 100 may shorten the period during which a verification-subject pattern that has not been verified in terms of having a high or low possibility of preventing an occurrence of a traffic accident is allocated to a vehicle group and thereby may suppress the occurrence of a traffic accident involving the vehicle group during the test period.

In particular, the determining apparatus 100 allocates the pattern P1 to the vehicle group G1 for the first 2-days of the test period, allocates the pattern P5 for the next 2 days, again allocates the pattern P1 for the next 5 days, and allocates the pattern P2 for the next 5 days. The determining apparatus 100, similarly, allocates the patterns P1 to P5 to the vehicle groups G2 to G4.

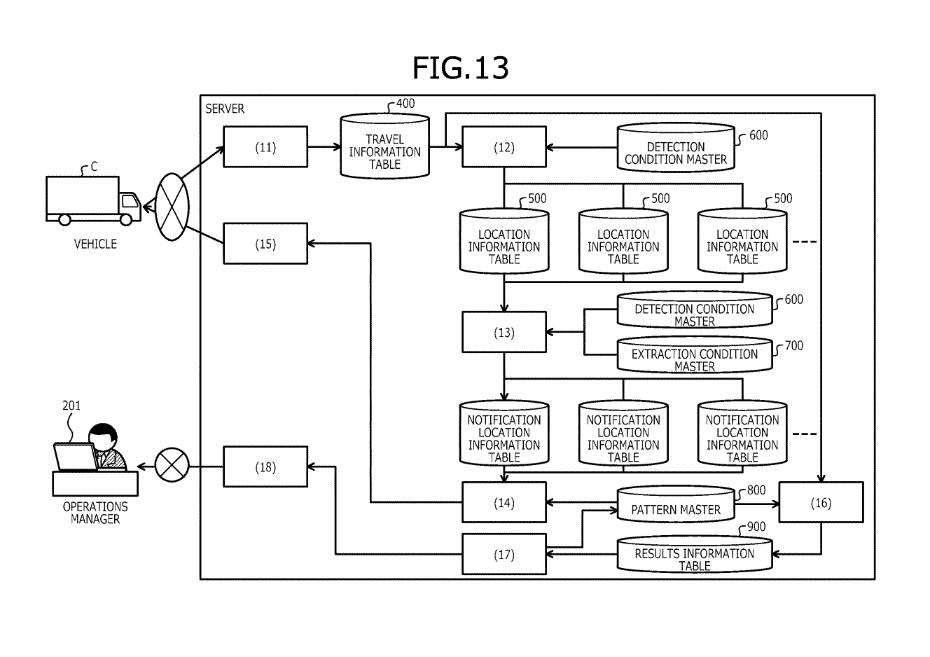

The determining apparatus 100, when the test period ends, may return the pattern that is to be applied to the vehicle groups G1 to G4 to the pattern allocated to each of the vehicle groups G1 to G5 before the start of the test period. Next, description is given using FIG. 13.

FIG. 13 is a diagram depicting a flow of trigger condition determination. In the example depicted in FIG. 13, the determining apparatus 100 has allocated a fixed pattern and a newly generated verification-subject pattern to plural vehicle groups during a test period.

(11) The determining apparatus 100 receives the travel information R from the onboard vehicular apparatus N equipped on each of the vehicles C included in each of the plural vehicle groups. The determining apparatus 100, for example, receives the travel information R from the vehicles C each time the travel information R is generated by the vehicles C. Further, the determining apparatus 100 may collectively receive the travel information R generated for a certain time period by the vehicle C. The determining apparatus 100 updates the travel information table 400 based on the received travel information R.

(12) The determining apparatus 100 refers to the travel information table 400 and the detection condition master 600 to calculate for each location having a rectangular shape and predetermined size, a count of the vehicles C passing through the location and a count of the vehicles C that have braked suddenly in the location. The determining apparatus 100, for example, calculates for each location having a rectangular shape and predetermined size, a count of the vehicles C passing through the location, based on travel information collected for past periods corresponding to the period in the collection period field.

Further, for example, based on the travel information collected for past periods corresponding to the period in the collection period field, the determining apparatus 100 calculates as the sudden braking count, a count of instances in which acceleration in the rearward direction exceeds the value in the deceleration range field. The determining apparatus 100 updates the location information table 500 based on the calculated count of the passing vehicles C and count of the vehicles C that brake suddenly.

(13) The determining apparatus 100 refers to the detection condition master 600 and the extraction condition master 700 to extract a notification place from the location information table 500. The determining apparatus 100, for example, for each combination of a detection condition of the detection condition master 600 and extraction condition of the extraction condition master 700, extracts as a notification place, a zone prone to sudden braking satisfying the combination of the detection condition and the extraction condition. In particular, the determining apparatus 100, for each extraction condition, refers to a record satisfying the extraction condition among the records of the location information table 500 to update a notification place information table.

(14) The determining apparatus 100 refers to the notification place information table and the pattern master 800 to identify a notification place where notification in the vehicle C is to be performed in a pattern applied to each of the plural vehicle groups.

(15) The determining apparatus 100 transmits the notification place identified for each of the plural vehicle groups to the onboard vehicular apparatus N equipped on each of the vehicles C included in each of the plural vehicle groups. As a result, the onboard vehicular apparatus N may detect a place where notification in the vehicle C is to be given in a pattern applied to the vehicle C. The onboard vehicular apparatus N may give notification in the vehicle C, when the vehicle C enters a place where notification is to be given in the vehicle C.

Here, the determining apparatus 100 may recursively perform the processes at (11) to (15) for each specific period. As a result, the determining apparatus 100 may cope with instances in which a zone prone to sudden braking or a notification place has changed due to a change in road conditions, the passenger in the vehicle C becoming accustomed to notifications in the vehicle C, and the like. The determining apparatus 100 may extract and transmit the newest notification place to the onboard vehicular apparatus N. As a result, the onboard vehicular apparatus N may give notification in the vehicle C when the newest notification place is entered.

(16) The determining apparatus 100 refers to the travel information table 400 and the pattern master 800 to calculate for each prefecture, a count of the vehicles C passing and a count of the vehicles C braking suddenly corresponding to each of the patterns during each of the seasons. The determining apparatus 100 updates the results information table 900 based on the calculated sudden braking count, passed vehicle count, and ratio of the sudden braking count to the passed vehicle count.

(17) The determining apparatus 100 refers to the results information table 900 to select each of the fixed patterns and judge whether among the verification-subject patterns, a verification-subject pattern is present for which evaluation is better than that of the selected fixed pattern. Here, a better evaluation is a value in the ratio field of the results information table 900 being smaller. Here, when a verification-subject pattern having a better evaluation value is present, the determining apparatus 100 selects the verification-subject pattern for which the evaluation value is better.

The determining apparatus 100 resets, as a verification-subject pattern, the selected fixed pattern stored in the pattern master 800. Further, the determining apparatus 100 resets, as a fixed pattern, the selected verification-subject pattern stored in the pattern master 800. As a result, the determining apparatus 100 interchanges a fixed pattern and a verification-subject pattern and may set, as a fixed pattern, a pattern having a high possibility of preventing an occurrence of a traffic accident.

Further, the determining apparatus 100 may refer to the results information table 900 to select the pattern having the worst evaluation value of the fixed patterns and the verification-subject patterns. Here, the worst evaluation is the largest value in the ratio field of the results information table 900. The determining apparatus 100 deletes from the pattern master 800, the record corresponding to the selected pattern having the worst evaluation. Here, the determining apparatus 100 may receive a newly generated verification-subject pattern from the user of the determining apparatus 100 or from the client apparatus 201. The determining apparatus 100 may add to the pattern master 800, a record corresponding to the newly generated verification-subject pattern in place of the deleted record corresponding to the selected pattern. As a result, the determining apparatus 100 may verify whether a newly generated verification-subject pattern has a high or low possibility of preventing an occurrence of a traffic accident.

Here, the determining apparatus 100 may recursively perform the processes at (16) and (17) for each specific period. As a result, the determining apparatus 100 may cope with instances in which a high or low possibility of a pattern preventing an occurrence of a traffic accident changes due to a change in road conditions, the passenger in the vehicle C becoming accustomed to notifications in the vehicle C, and the like. In particular, the possibility of preventing an occurrence of a traffic accident may begin to decrease due to a passenger of a vehicle C becoming, over the course of time, accustomed to notifications in the vehicle C to which a pattern having a high possibility of preventing a traffic accident is applied.

In this case as well, the determining apparatus 100 may include the currently applied fixed pattern and verify whether the possibility of preventing an occurrence of a traffic accidently is high or low for each specific period. Therefore, when a verification-subject pattern has a higher possibility of preventing an occurrence of a traffic accident than a fixed pattern whose possibility of preventing an occurrence of a traffic accident has started to decrease, the determining apparatus 100 may replace the fixed pattern and again improve the possibility of preventing an occurrence of a traffic accident.

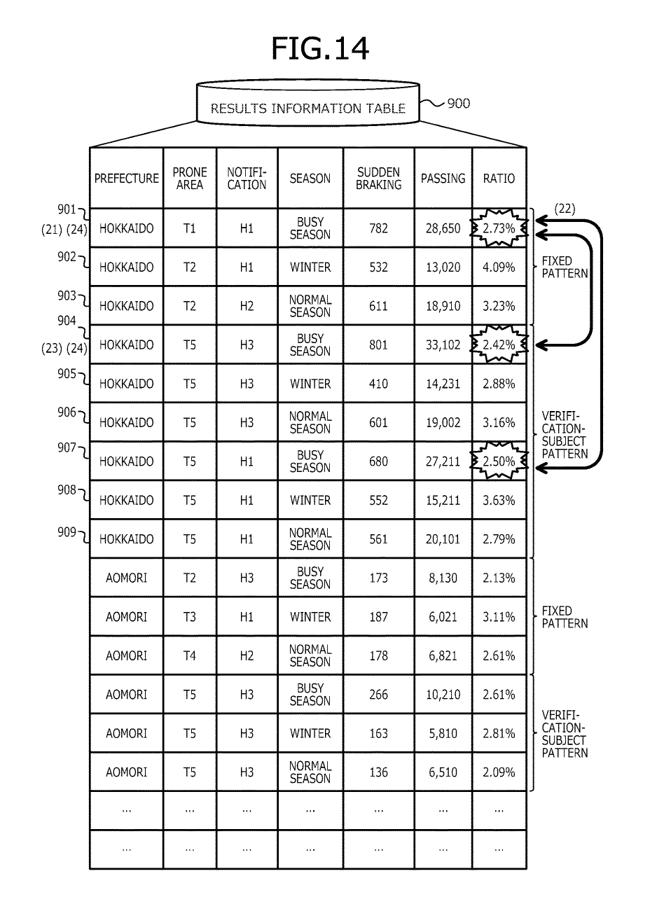

(18) The determining apparatus 100 transmits the contents of the pattern master 800 to the client apparatus 201. The client apparatus 201 displays the contents of the pattern master 800. As a result, the user of the client apparatus 201 may know the pattern of a trigger condition applied to the vehicle C in each of the prefectures. Next, description using FIG. 14 is given.

FIG. 14 is a diagram depicting an example of trigger condition replacement. In FIG. 14, (21) the determining apparatus 100 selects from records 901 to 909 corresponding to the prefecture “Hokkaido” stored in the results information table 900, the record 901 of a fixed pattern.

(22) The determining apparatus 100 compares the ratio in the record 901 and the ratio of each of the records 904, 907 of a verification-subject pattern that is stored in the results information table 900 and corresponds to the same season “busy season” for the same prefecture “Hokkaido” as the record 901.

(23) The determining apparatus 100, based on the results of the comparison, selects the record 904 of a verification-subject pattern for which the ratio is lower than that of the record 901 of the fixed pattern and for which the evaluation is better.

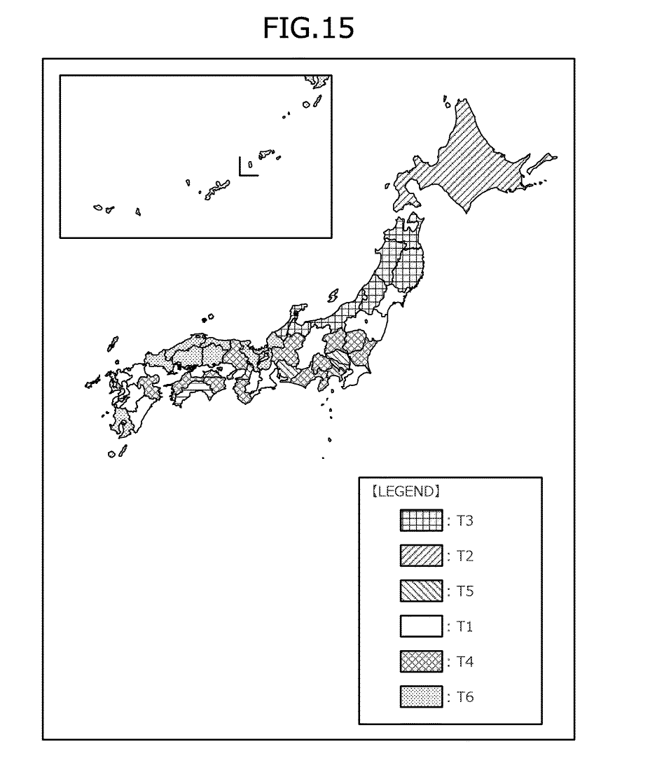

(24) The determining apparatus 100 sets the fixed pattern corresponding to the record 901 of the pattern master 800, as a verification-subject pattern. Further, the determining apparatus 100 sets the verification-subject pattern corresponding to the record 904 of the pattern master 800, as a fixed pattern. As a result, the determining apparatus 100 may interchange a fixed pattern and a verification-subject pattern to set a pattern having a higher possibility of preventing an occurrence of a traffic accident, as a fixed pattern. Next, description is given using FIG. 15.

FIG. 15 is a diagram depicting an example of an output screen. In FIG. 15, the determining apparatus 100 transmits the contents of the pattern master 800 to the client apparatus 201. The client apparatus 201 refers to the contents of the pattern master 800 and displays a screen representing a fixed pattern applied to each of the prefectures. In the example depicted in FIG. 15, the client apparatus 201 refers to the contents of the pattern master 800 and among fixed patterns applied to each of the prefectures, displays a screen representing what the detection condition is.

As a result, the user of the client apparatus 201 may know the fixed pattern applied to each of the prefectures. The user of the client apparatus 201, for example, may know for which season and in which region, a pattern of what type of trigger condition is effective in preventing an occurrence of a traffic accident. The user of the client apparatus 201 may newly generate a verification-subject pattern having a possibility of being effective in preventing an occurrence of a traffic accident, may determine what type of pattern to apply for which season and in which region, etc. When a pattern effective in preventing an occurrence of a traffic accident in Hokkaido in the winter is present, the user of the client apparatus 201, for example, may use the pattern for Nagano in the winter, or the like.

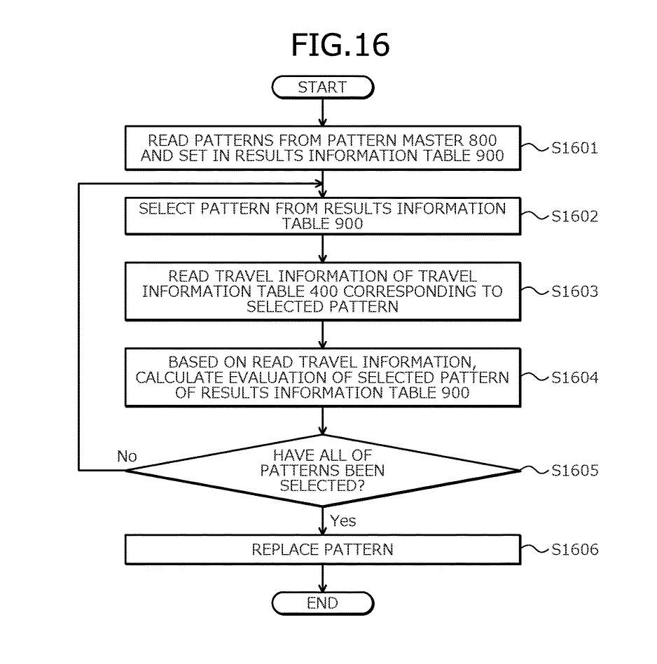

An example of a procedure of a replacement process executed by the determining apparatus 100 is described with reference to FIG. 16.

FIG. 16 is a flowchart depicting an example of a procedure of a replacement process. In FIG. 16, the determining apparatus 100 reads patterns from the pattern master 800 and sets the patterns in the results information table 900 (step S1601).

Next, the determining apparatus 100 selects a pattern from the results information table 900 (step S1602). The determining apparatus 100 reads the travel information R of the travel information table 400 corresponding to the selected pattern (step S1603).

Next, the determining apparatus 100, based on the read travel information R, calculates an evaluation of the selected pattern of the results information table 900 (step S1604). The determining apparatus 100 determines whether all of the patterns have been selected (step S1605). When a pattern has yet to be selected (step S1605: NO), the determining apparatus 100 returns to step S1602.

On the other hand, when all of the patterns have been selected (step S1605: YES), the determining apparatus 100, when a pattern having a worse evaluation than a pattern for comparison is among the fixed patterns of the results information table 900, replaces the pattern with a verification-subject pattern (step S1606). The determining apparatus 100 ends the procedure of the replacement process. As a result, the determining apparatus 100 may interchange a fixed pattern and a verification-subject pattern to set a pattern having a high possibility of preventing an occurrence of a traffic accident, as a fixed pattern.

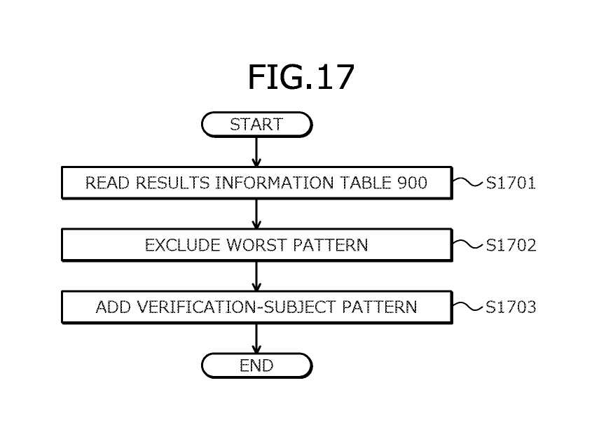

An example of a procedure of an exclusion process is described with reference to FIG. 17.

FIG. 17 is a flowchart depicting an example of a procedure of an exclusion process. In FIG. 17, the determining apparatus 100 reads the results information table 900 (step S1701). Next, the determining apparatus 100 refers to the results information table 900 to identify a worst pattern having the worst evaluation and excludes the record corresponding to the worst pattern from the pattern master 800 (step S1702).

The determining apparatus 100 adds a verification-subject pattern to the pattern master 800 (step S1703). The determining apparatus 100 ends the exclusion process. As a result, the determining apparatus 100 may prevent the worst pattern having a low possibility of preventing an occurrence of a traffic accident from being applied to a vehicle group and thus, may enhance the safety of the vehicle group. Further, the determining apparatus 100 may verify whether a newly generated verification-subject pattern has a high or low possibility of preventing an occurrence of a traffic accident.

As described, the determining apparatus 100 enables each pattern candidate of a trigger condition to be distributed and allocated to plural vehicle groups. The determining apparatus 100 enables a trigger condition corresponding to each allocated pattern candidate to be evaluated based on a change in the travel information R before and after application of the trigger condition corresponding to the allocated pattern candidate. The determining apparatus 100 enables a trigger condition having a relatively high evaluation or satisfying a predetermined standard among plural trigger conditions to be set as a trigger condition to be applied in a service provided to the plural vehicle groups, among the plural trigger conditions. As a result, the determining apparatus 100 may determine a condition enabling effective control in the vehicle C. The determining apparatus 100 may determine as a pattern of a trigger condition among pattern candidates of trigger condition, for example, a pattern having a high possibility of preventing a traffic accident after application. The determining apparatus 100 may apply the determined pattern of a trigger condition to a vehicle group, enabling the possibility of preventing a traffic accident to be increased.

Further, the determining apparatus 100 enables use of a condition identifying a dangerous driving-operation occurring point, as a trigger condition. As a result, when the vehicle C enters a dangerous driving-operation occurring point, the determining apparatus 100 may be set to perform control in the vehicle C. The determining apparatus 100 may prevent an occurrence of a traffic accident at a dangerous driving-operation occurring point.

The determining apparatus 100 enables use of a condition identifying a distance to a dangerous driving-operation occurring point, as a trigger condition. As a result, when the distance to a dangerous driving-operation occurring point is a certain distance or less, the determining apparatus 100 may be set to perform control in the vehicle C. The determining apparatus 100 may prevent an occurrence of a traffic accident at a dangerous driving-operation occurring point. The determining apparatus 100 may prevent an occurrence of a traffic accident in, for example, a zone prone to sudden braking, a zone prone to rapid acceleration, a zone prone to abrupt steering actions, etc.

The determining apparatus 100 enables use of notification in the vehicle C as control in a vehicle C according to the driving operation. As a result, the determining apparatus 100 may perform notification in the vehicle C traveling in a notification place to prevent an occurrence of a traffic accident.

After application of each of the trigger conditions, when the predetermined test period elapses, the determining apparatus 100 may return the trigger condition for the vehicle group to the trigger condition before the test. As a result, the determining apparatus 100 the pattern of a trigger condition to be applied to a vehicle group may be returned from a verification-subject pattern subject to verification of the possibility of preventing an occurrence of a traffic accident to the originally applied pattern having a high possibility of preventing an occurrence of a traffic accident. Therefore, the determining apparatus 100 may enhance the safety of the vehicle group.

The determining apparatus 100 enables a trigger condition not satisfying a predetermined standard or having a relatively low evaluation among plural trigger conditions to be set as a trigger condition that is not to be applied in a service to plural vehicle groups. As a result, the determining apparatus 100 may prevent a worst pattern having a low possibility of preventing an occurrence of a traffic accident from being applied to a vehicle group, enabling the safety of the vehicle groups to be enhanced.

The determining apparatus 100 enables a trigger condition that is among plural trigger conditions and obtained by travel data that after application to another vehicle group improved as compared to before application to be applied to a vehicle group to which a service is to be provided under a predetermined contract. As a result, the determining apparatus 100 may change the contents of an operation support service to be provided to the manager of a vehicle group, depending on the contents of the contract entered with the manager of the vehicle group. The determining apparatus 100 may increase the possibility of preventing a traffic accident involving the vehicle group according to the needs of the manager with whom a predetermined contract is entered.

The determining apparatus 100 enables a trigger condition that is selected from a trigger condition group to replace the current trigger condition and for which improvement is detected before and after application first contract to be applied to the vehicle group to which a service is to be provided under a contract to which a first contract is applied. As a result, the determining apparatus 100 may change the contents of an operation support service to be provided to the manager of a vehicle group, depending on the contents of the contract entered with the manager of the vehicle group. The determining apparatus 100 may increase the possibility of preventing a traffic accident involving the vehicle group according to the needs of the manager with whom a predetermined contract is entered.

The determining apparatus 100 enables a trigger condition selected from among predetermined trigger conditions to be applied a vehicle group to which a service is to be provided under a contract to which a second contract is not applied. As a result, the determining apparatus 100 may allocate to a vehicle group, a verification-subject pattern that has not been verified in terms of having a high or low possibility of preventing an occurrence of a traffic accident.

Here, conventionally, it is conceivable that a computing apparatus extracts for each vehicle C, a notification place from among places passed the vehicle C and gives notification in the vehicle C when the vehicle C passes the notification place. However, in this case, when the number of the vehicles C is enormous, the amount of processing for extracting notification places also becomes enormous, increasing the load on the computing apparatus. Further, the computing apparatus cannot extract a notification place for places that the vehicle C has not yet passed and therefore, an occurrence of a traffic accident may not be prevented.

On the other hand, the determining apparatus 100 according to the present embodiment may determine a pattern of a trigger condition having a high possibility of preventing an occurrence of a traffic accident, based on the travel information R of the plural vehicles C. Therefore, even for a place that a certain vehicle C has not passed before, the determining apparatus 100 may perform notification in the vehicle C when the place is one that other vehicle C has passed, enabling an occurrence of a traffic accident to be prevented.

The trigger condition determining method described in the present embodiment may be implemented by executing a prepared program on a computer such as a personal computer and a workstation. A trigger condition determining program is stored on a non-transitory, computer-readable recording medium such as a hard disk, a flexible disk, a CD-ROM, an MO, and a DVD, read out from the computer-readable medium, and executed by the computer. The trigger condition determining program may be distributed through a network such as the Internet.

Nonetheless, with the convention techniques described above, it is difficult to judge what type of place and in what situation, control in a vehicle is to be performed so that, for example, an occurrence of a traffic accident is suppressed and the burden on a passenger of a vehicle may be reduced by preventing excess notification.

According to one aspect of the present invention, an effect is achieved in that a condition may be determined that enables control in a vehicle to be effectively performed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a trigger condition determining program that causes a computer to execute a process comprising:
distributing and allocating a pattern candidate to a plurality of vehicle groups when a plurality of pattern candidates of a trigger condition for control in a vehicle corresponding to driving operation is present, the pattern candidate being each pattern candidate of the plurality of pattern candidates;
evaluating the trigger condition corresponding to the allocated pattern candidate, based on a change in travel information before and after an application of the trigger condition corresponding to the allocated pattern candidate; and
setting among a plurality of the trigger conditions, a trigger condition having a relatively high evaluation or satisfying a predetermined standard, to be a trigger condition that is to be applied in a service provided to the plurality of vehicle groups.

2. The recording medium according to claim 1, wherein
the trigger condition is a condition identifying a dangerous driving-operation occurring point.

3. The recording medium according to claim 1, wherein
the trigger condition is a condition identifying a distance to a dangerous driving-operation occurring point.

4. The recording medium according to claim 2, wherein
the dangerous driving-operation occurring point is any one of a zone prone to sudden braking, a zone prone to rapid acceleration, and a zone prone to abrupt steering actions.

5. The recording medium according to claim 3, wherein
the dangerous driving-operation occurring point is any one of a zone prone to sudden braking, a zone prone to rapid acceleration, and a zone prone to abrupt steering actions.

6. The recording medium according to claim 1, wherein
the control in the vehicle corresponding to the driving operation is notification given in the vehicle.

7. The recording medium according to claim 1, the process comprising
returning to a trigger condition before the application, after application of each of the plurality of the trigger conditions after a predetermined test period elapses.

8. The recording medium according to claim 1, the process comprising
setting among the plurality of the trigger conditions, a trigger condition having a relatively low evaluation or not satisfying a predetermined standard, to be a trigger condition that is not to be applied in the service provided to the plurality of vehicle groups.

9. The recording medium according to claim 1, the process comprising
applying to a vehicle group to which a service is to be provided under a predetermined contract, a trigger condition among the plurality of the trigger conditions and obtained by travel data that after application of the trigger condition to another vehicle group improved as compared to before the application.

10. The recording medium according to claim 1, the process comprising:
applying to a vehicle group to which a service is to be provided under a contract to which a first contract applies, a trigger condition selected from a trigger condition group of replacement trigger conditions for which post-application improvement is detected, based on collected travel data; and
applying to a vehicle group to which a service is to be provided under a contract to which a second contract does not apply, a trigger condition selected from predetermined trigger conditions.

11. A trigger condition determining method comprising:
distributing and allocating, by a processor, to a plurality of vehicle groups, a pattern candidate when a plurality of pattern candidates of a trigger condition for control in a vehicle corresponding to driving operation is present, the pattern candidate being each pattern candidate of the plurality of pattern candidates;
evaluating, by the processor, the trigger condition corresponding to the allocated pattern candidate, based on a change in travel information before and after an application of the trigger condition corresponding to the allocated pattern candidate; and
setting among a plurality of the trigger conditions, by the processor, a trigger condition having a relatively high evaluation or satisfying a predetermined standard to be a trigger condition that is to be applied in a service provided to the plurality of vehicle groups.

12. A trigger condition determining apparatus comprising:
a memory; and
a processor coupled to the memory, the processor configured to:
distribute and allocate to a plurality of vehicle groups, a pattern candidate when a plurality of pattern candidates of a trigger condition for control in a vehicle corresponding to driving operation is present, the pattern candidate being each pattern candidate of the plurality of pattern candidates;
evaluate the trigger condition corresponding to the allocated pattern candidate, based on a change in travel information before and after an application of the trigger condition corresponding to the allocated pattern candidate; and
set among a plurality of the trigger conditions, a trigger condition having a relatively high evaluation or satisfying a predetermined standard to be a trigger condition that is to be applied in a service provided to the plurality of vehicle groups.
